(19) United States
(12) Patent Application Publication
(10) Pub. No.: US 2017/0278416 A1
(43) Pub. Date: Sep. 28, 2017

(54) SELECT A QUESTION TO ASSOCIATE WITH A PASSAGE

(71) Applicant: Hewlett-Packard Development Company, L.P., Houston, CA (US)

(72) Inventors: Lei LIU, Palo Alto, CA (US); Jerry LIU, Palo Alto, CA (US)

(21) Appl. No.: 15/514,462

(22) PCT Filed: Sep. 24, 2014
(86) PCT No.: PCT/US2014/057150

§ 371 Date: Mar. 24, 2017

(51) Int. Cl. G09B 7/02; G06F 17/27

(52) U.S. Cl. CPC G09B 7/02; G06F 17/278; G06F 17/274; G06F 17/2785

(57) ABSTRACT

Examples disclosed herein relate to selecting a question to associate with a passage. A processor may categorize a subset of terms appearing in a passage and compare the terms and their categories to the categorized terms associated with the questions to determine similarity levels between the passage and the questions. The processor may select at least one of the questions based on its relative similarity level compared to similarity levels of the other questions and output information related to the selected question.

### BACKGROUND

Educators may provide questions to students to both test comprehension and analytical skills. For example, inferential questions may ask students about events similar to those described in the passage, how they would respond to a similar situation, and other questions to invoke thinking related to the passage. Inferential questions may be useful to enhance the educational value of the passage by causing the reader to think more broadly about the concepts in the passage.

### BRIEF DESCRIPTION OF THE DRAWINGS

The drawings describe example embodiments. The following detailed description references the drawings, wherein:

FIG. 1 is a block diagram illustrating one example of a computing system to select a question to associate with a passage.

FIG. 2 is a flow chart illustrating one example of a method to select a question to associate with a passage

FIG. 3 is a block diagram illustrating one example of tags used to describe a passage to select a question to associate with the passage.

FIG. 4 is a block diagram illustrating one example of selecting a question to associate with a passage.

### DETAILED DESCRIPTION

In one implementation, a processor compares a repository of questions to a passage to determine questions to associate with the passage. The questions may reflect topics, people, and concepts from the passage, and may provide analytical questions for writing prompts or discussion beyond basic comprehension details of the passage. For example, the questions may be inferential how and why questions not directly related to the passage itself. In one implementation, the questions are taken from online question repositories, such as from websites or backend online question repositories associated with the websites. In some cases, the websites may be question and answer forums. Associating a question with a passage may involve matching a shorter question with a longer passage. In some implementations, additional information associated with the question, such as a document including the question, may also be compared to the passage. The document may be, for example, a document in a document repository or a web page. The processor may categorize terms in the passage and categorize terms in and associated with a set of questions. The processor may then select a question to associate with the passage based on a similarity between the categorized terms. Using categorized terms to associate the question and passage may be useful for associating questions and passages across multiple domains without prior knowledge of information about the type of passage.

Automatically associating analytical questions with a reading passage may be particularly useful for classes where students are each reading different passages according to different interests and difficulty levels. In such cases, it would be challenging for a teacher to create questions for each text. In one implementation, the processor takes into account additional factors such that different questions are associated with the same passage for different students or classes.

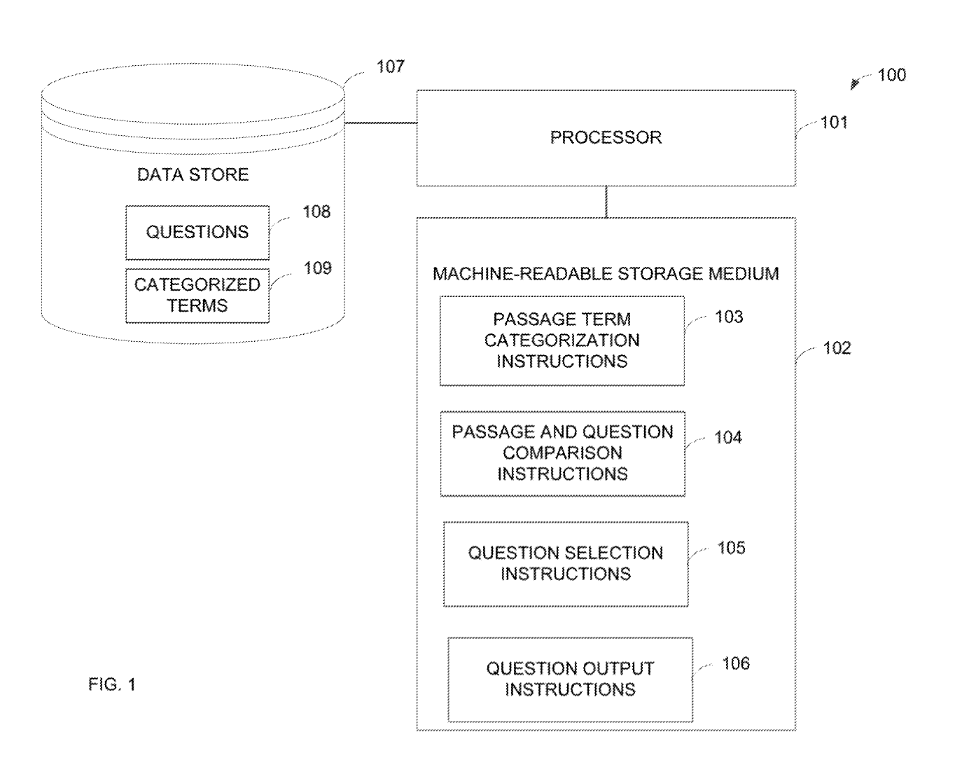

FIG. 1 is a block diagram illustrating one example of a computing system 100 to select a question to associate with a passage. For example, the question may stimulate deeper thinking related to the concepts described in the passage. The question may be inferential such that it may not be directly created from the passage and may originate from a separate source than the passage. The computing system 100 includes a processor 101, a data store 107, and a machine-readable storage medium 102.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (lCs) or other electronic circuits that comprise a plurality of electronic components for performing the functionality described below. The functionality described below may be performed by multiple processors. The processor 101 may execute instructions stored in the machine-readable storage medium 102.

The data store 107 includes questions 108 and categorized terms 109. The questions 108 may be any suitable questions. In some cases, the questions 108 may be questions available via the web that are not tailored to education. In one implementation, the processor 101 or another processor identifies questions, such as from a website or backend online question repository, and stores the questions in the data store 107. The data store 107 may include documents related to particular purpose, such as a set of training manuals for a particular product. The processor 101 may perform some preprocessing to determine whether the identified question would likely be suitable for educational purposes. The data store 107 may be periodically updated with new data, such as a weekly comparison of the stored questions to new questions on a question and answer forum. The processor 101 may communicate directly with the data store 107 or via a network. In one implementation, the questions are categorized, such as based on their source or the questions themselves. For example, a teacher may indicate that he prefers questions to be selected from a particular type of website or a particular set of websites.

The categorized terms 109 may be terms appearing within the question along with an associated category for each of the terms. For example, the term may be “United States”, and the category may be “Location”. The terms and categories may be related to both the question itself and information surrounding the question, such as additional information on a website displaying the question. The terms may be identified and categorized by the processor 101 executing instructions stored in the machine-readable storage medium 102.

The machine-readable storage medium 102 may be any suitable machine readable medium, such as an electronic, magnetic, optical, or other physical storage device that stores executable instructions or other data (e.g., a hard disk drive, random access memory, flash memory, etc.) The machine-readable storage medium 102 may be, for example, a computer readable non-transitory medium. The machine-readable storage medium 102 may include passage term categorization instructions 103, passage and question comparison instructions 104, question selection instructions 105, and question output instructions 106.

The passage term categorization instructions 103 may include instructions to categorize a subset of terms appearing in a passage. For example, stop words and other words may be disregarded from the passage. The passage term categorization instructions 103 may include instructions to perform preprocessing on the terms, such as to stem the terms. The categories may be any suitable categories, such as an entity or part of speech. The categorization may be performed, for example, by building or accessing a statistical model and the applying the model to the passage. There may be separate models for categorizing parts of speech than for entities. Categories may also be associated with groups of terms or concepts associated with terms.

The passage and question comparison instructions 104 may include instructions to compare the terms and their categories to the categorized terms associated with the questions in the data store 107 to determine similarity levels between the passage and the questions.

The question selection instructions 105 may include instructions to select at least one of the questions based on its relative similarity level compared to similarity levels of the other questions. Determining the similarity level may involve determining a mathematical distance between the categories and terms of the passage from the categories and terms of the question, such as terms appearing within the question and in information associated with the question. The similarity level of the different questions to the passage may be compared such that questions with similarity scores above a threshold, questions with the top x % scores, and/or the top N questions may be selected.

The question output instructions 106 may include instructions to output information related to the selected question. The question may be output by storing information about the association, transmitting, and/or displaying it. The question may be displayed in educational material associated with the passage, such as digital educational content.

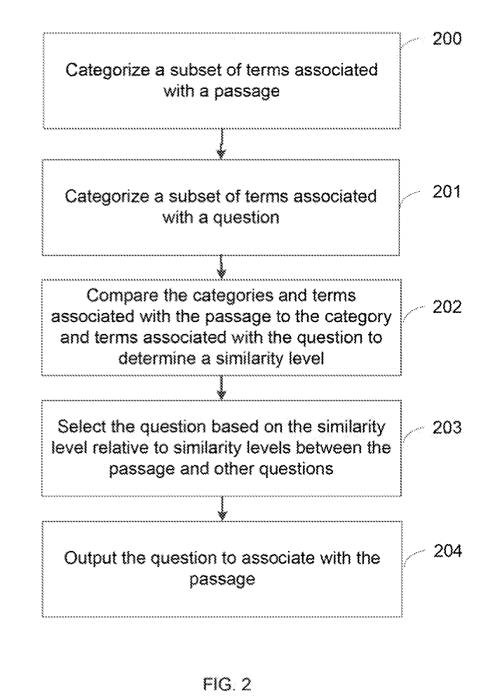

FIG. 2 is a flow chart illustrating one example of a method to select a question to associate with a passage. An analytical question to stimulate writing or discussion related to the, passage may be selected to associate with the passage. For example, a processor may automatically associate a question with a passage based on a comparison of categorized terms in the passage to categorized terms in the question and to categorized terms associated with the question. The method may be implemented, for example, by the computing system 100 of FIG. 1.

Beginning at 200, a processor categorizes a subset of terms associated with a passage. The passage may be any suitable passage, such as a page, paragraph, or chapter of a print or digital work. The processor may determine a subset of terms in the passage to have a significance, such as after removing articles or other common words. Preprocessing may also involve word stemming or other methods to make the terms more comparable to one another. The categories may be any suitable categories, such as parts of speech, such as noun, verb, or adjective, or an entity, such as a person, location, organization geo-political entity, facility, date, money, percent, or time. In some cases, the same term may belong to multiple categories.

The processor may locate and categorize entities in the passage in any suitable manner. The processor may compare the terms to a set entity list and/or use a predictive model. In one implementation, the processor analyzes a body of entity tags and trains a model on the body, such as using Hidden Markov Model (HMM), Conditional Random Field (CRF), Maximum Entropy Models (MEMS), or Support Vector Machines (SVM). The built model may be applied to new passages. In one implementation, the processor selects a model to be applied to a particular passage, such as based on the subject of the passage. Similarly, the processor may locate and categorize parts of speech in any suitable manner. For example, the processor may build or access a rule based tagging model. For example, a Stochastic Tagger model, such as Hidden Markov Model (HMM), may be used. The processor may apply the model to locate and categorize parts of speech within the passage.

In one implementation, a term may be associated with both an entity and part of speech, such as where nouns are processed to determine if they also fit an entity category. Categorizing the terms may ensure that the same type of use is being compared in the passage as in the question. In some cases, a category may relate to the passage as a whole or a larger group of terms in the passage, such as a category for a topic.

Continuing to 201, a processor categorizes a subset of terms associated with a question. The question may be any suitable question stored in a question repository. In one implementation, the processor selects a subset of questions to analyze based on additional factors, such as the difficulty level, high level subject, or source of the questions. The processor may categorize terms appearing within the question and terms associated with the question. For example, the terms appearing in the question and appearing in a document, such as appearing in a PDF or on a website, including the question may be identified. The additional terms may include terms appearing in suggested answers to a question, such as on a question and answer online forum. The initial set of terms may be preprocessed such that stop words and other words with little significance are not categorized and such that terms are stemmed. The processor may receive the questions in any suitable manner, such as via a data store. The data store may be populated with questions from a website, backend online question repository, or other methods. In one implementation, some of the questions are part of a web based question and answer forum, such as where users pose the questions. The terms associated with the question may be categorized in any suitable manner, such as based on entity and part of speech. The same method may be used to categorize the question terms as the passage terms, or a different method may be used.

Continuing to 202, a processor compares the categories and terms associated with the passage to the category and terms associated with the question to determine a similarity level. The similarity may be determined in any suitable manner, such as based on a mathematical distance from the passage keywords and categories to the webpage keywords and categories. In one implementation, the processor creates a matrix with a first row representative of the passage and the remaining rows representative of the questions. The entries may represent term and category pairs, such as a pair best/adjective or George Washington/person. in one implementation, the processor determines a relevance measure by comparing distance between the term and category pairs associated with the questions to the term and category pairs associated with the passage. The similarity measure may be for example, a cosine similarity, Euclidean distance, RBF kernel, or any other method for determining a distance between sets. As one example, a similarity score may be determined for a term category pair as:

$$similarity score ( x , {x}_{i} ) = \frac{x \cdot {x}_{i}}{‖ x ‖ ‖ {x}_{i} ‖} ,$$

where x is a vector with each element representing a term and category pair from a passage, and xᵢ is a vector with each vector element representing a term and category pair from the i-th question associated with a document,

In one implementation, the part of speech pairs and the entity pairs may be weighted different, such as where the entity categorization is given more weight in the similarity determination.

Additional information may also be taken into account. For example, information on a website from other viewers about how helpful the question was. In some cases, additional information may be determined or known about the question or the text associated with the question. For example, the type of website on which the question appears, the topic of the question, or difficulty of the question may be taken into account, such as where the processor selects a subset of the questions to compare to the passage based on the additional information associated with the question and/or user. A user profile may indicate that first user prefers science related questions and another prefers history related questions associated with the passage.

Continuing to 203, a processor selects the question based on the similarity level relative to similarity levels between the passage and other questions. For example, a similarity score may be assigned to each question, and the processor may select the top N, top N %, or questions with a score above a threshold. In one implementation, both a threshold and additional selection mechanism are used, such as where questions with a similarity score above a threshold are considered, and the top N questions with scores above the threshold are selected such that in some cases fewer than N questions are selected due to the threshold.

In one implementation, different questions are associated with different portions of the passage. For example, the passage may be segmented into blocks, such as using a topic model, and a topic associated with each block. A different question may be associated with each of the topic blocks.

Continuing to 204, a processor outputs the question to associate with the passage. The processor may store, display, or transmit information about the associated question. In one implementation, a set of associated questions are selected and displayed to a user, such as an educator, via a user interface. The user may select a subset of the questions to associate with the passage. In one implementation, a student's answer to the question is evaluated to determine what content to present to the student next. In some cases, multiple questions may be displayed to a student such that the student may select one of the questions as an essay prompt or other assignment.

In one implementation, the processor automatically compares thee answer to answers associated with the question, such as the answers provided on a question and answer forum. For example, the processor may determine a semantic topic associated with the answer provided with the question, such as on a webpage, and a topic associated with the answer to the question provided by a user. The processor may determine a degree of similarity between the semantic topics and identify a correct answer where the similarity is above a threshold.

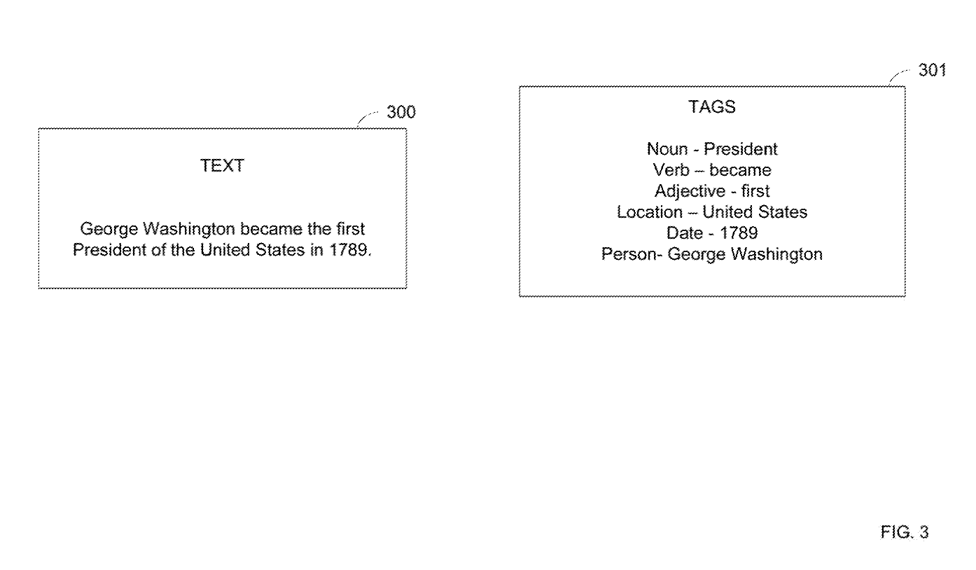

FIG. 3 is a block diagram illustrating one example of tags used to describe a passage to select a question to associate with the passage. The passage 300 shows a sentence excerpt from a passage, and tags 301 show terms and associated categories for the passage 300. For example, the categories include parts of speech, such as noun, verb, and adjective, and entities, such as location, date, and person. As an example, the term “president” is tagged as a noun.

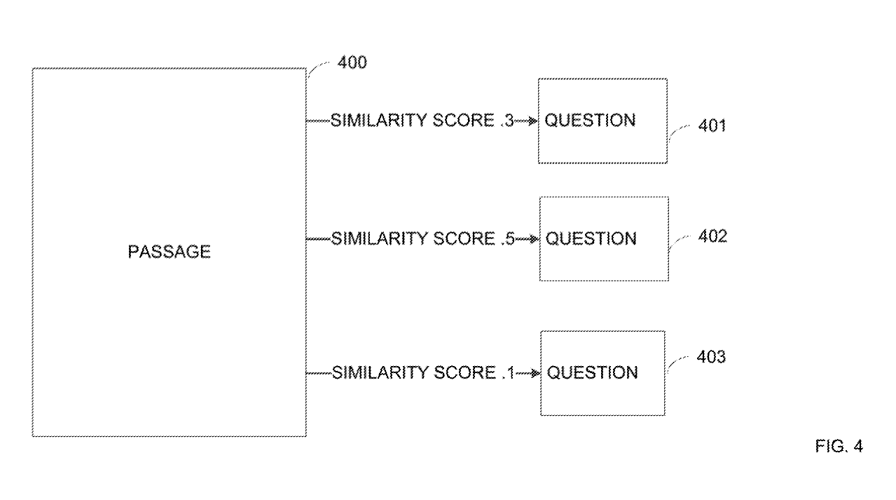

FIG. 4 is a block diagram illustrating one example of selecting a question to associate with a passage, For example, there is a passage 400 and questions 401, 402, and 403. There is a similarity score associated with each question. The similarity score may be determined based on a similarity of category and term pairs of the passage 400 to the category and term pairs of the questions. For example, the similarity score between passage 400 and question 402 is 0.5. Question 402 may be selected to be output to be associated with the passage 400 because it has the highest similarity score. Automatically associating questions with a passage may allow for inferential study questions to be generated with little teacher involvement.

1. A system, comprising:
a data store to store questions and categorized terms associated with the questions;
a processor to:
categorize a subset of terms appearing in a passage;
compare the terms and their categories to the categorized terms associated with the questions to determine similarity levels between the passage and the questions;
select at least one of the questions based on its relative similarity level compared to similarity levels of the other questions; and
output information related to the selected question.

2. The computing system of claim 1, wherein the processor is further to:
identify a question associated with a document;
categorize a subset of the terms associated with the document; and
store information related to the categorized terms in the data store.

3. The computing system of claim 1, wherein the similarity level comprises a mathematical distance between the categories and terms of the passage from the categories and terms of the question.

4. The computing system of claim 1, wherein the categories comprise at least one of: an entity and a part of speech.

5. The computing system of claim 1, wherein the processor further determines a category associated with multiple terms included together and uses the category to determine similarity level.

6. The computing system of claim 1, wherein outputting information related to the question comprises displaying the question in education material associated with the passage.

7. A computer implemented method, comprising:
categorizing a subset of terms associated with a passage;
categorizing a subset of terms associated with a question, wherein the terms associated with the question include the terms within the question and terms within text accompanying the question;
comparing the categories and terms associated with the passage to the category and terms associated with the question to determine a similarity level;
selecting the question based on the similarity level relative to similarity levels between the passage ands other questions; and
outputting the question to associate with the passage.

8. The method of claim 7, wherein categorizing the subset of terms associated with the question comprises categorizing a subset of terms related to a document including the question.

9. The method of claim 7, wherein the question is associated with an online based question and answer forum.

10. The method of claim 7, wherein the categories comprises at least one of: a part of speech and an entity.

11. The method of claim 7, further comprising determining a category associated with the passage as a whole and using the category to determine the similarity level.

12. A machine-readable non-transitory storage medium comprising instructions executable by a processor to:
identify questions associated with multiple documents;
determine at least one of the questions to associate with a passage based on a comparison of the passage to the question and the document including the question; and
output the determined question.

13. The machine-readable non-transitory storage medium of claim 12, further comprising instructions to:
identify keywords in the passage and a category associated with each of the keywords;
identify keywords within the document and a category associated with each of the keywords, and
wherein the comparison is based on a comparison of the passage keywords and categories to the document keywords and categories.

14. The machine-readable non-transitory storage medium of claim 13, wherein instructions to compare the passage to the question and the document comprise instructions to determine a mathematical distance from the passage keywords and categories to the documnt keywords and categories.

15. The machine-readable storage medium of claim 12, wherein the categories comprise at least one of: a part of speech and an entity.
